(19) United States
(12) Patent Application Publication
(10) Pub. No.: US 2003/0050126 A1
(43) Pub. Date: Mar. 13, 2003

(54) Driveline assembly with reduced standout

(76) Inventor: Bradley A. Arnold, Grandville, OH (US)

Correspondence Address: CARLSON, GASKEY & OLDS, P.C., 400 WEST MAPLE ROAD, SUITE 350, BIRMINGHAM, MI, 48009, US

(21) Appl. No.: 09/947,747

(22) Filed: Sep. 7, 2001

(51) Int. Cl. F16C 1/26; F16D 3/84

(52) U.S. Cl. 464/178

(57) ABSTRACT

A driveline assembly includes a driveshaft that is coupled to an input shaft for a tandem drive axle. The tandem axle includes a forward-rear axle connected to a rear-rear axle with an interaxle driveshaft. A universal joint connects an output shaft from the forward-rear axle to the interaxle driveshaft. The universal joint includes a first yoke member that is supported on the output shaft and a second yoke member that is supported on the interaxle driveshaft. The first yoke member is integrally formed with the output shaft as one piece to reduce standout and assembly weight.

### BACKGROUND OF THE INVENTION

This invention relates to an integrated driveline component that reduces standout and weight. Specifically, shaft and yoke members are integrally formed as one piece to reduce standout and assembly weight.

Most vehicle drivelines include drive axles that are connected to a driveshaft or other driveline component with a universal joint. Universal joints, or U-joints, are utilized on most vehicle drivelines. One common type of U-joint is known as a Cardon universal joint. In this type U-joint, two yokes each have two locating journals at diametrically opposed positions. Each yoke is mounted typically to two diametrically opposed posts on a cross member. The combination allows the two yokes to move angularly relative to each other with respect to the center of the cross member.

The U-joint allows two shaft components to be oriented at different angles relative to each other to accommodate relative movement and angular misalignment while transmitting torque. U-joint connections are used to interconnect driveline components that are not mounted to the vehicle in a straight line.

For example, the driveshaft powered by a vehicle engine provides input, via a transmission, to a center differential of a single drive axle. The center differential has an input shaft that is coupled to the driveshaft with a u-joint assembly. In another example, the driveshaft provides input to a tandem axle having a forward-rear axle connected to a rear-rear axle with an interaxle driveshaft. Universal joint assemblies connect both axles to that interaxle driveshaft as well as connecting the input driveshaft to the forward-rear axle.

Driveline operational angles are affected by the “standout” of the axle. Standout is defined as the centerline of the axle to a washer mounting surface of the yoke. Functionally, standout is the distance from the centerline of the axle to the centerline of the u-joint. Standout is negative to driveline angularity. A driveline operational angle is defined as the angle between the shaft centerline of the yoke to the centerline of the driveshaft. Preferably, the operational angle at one end of a driveshaft is equal or close to the operational angle at the opposite end of the driveshaft. If the angles are equal or close to each other, the driveline angles are said to cancel. If the operational angles are sufficiently different at opposing ends of a driveshaft or, if either or both angles are large relative to driveshaft speed, then driveline vibration, noise and poor durability will result. Further, the longer the standout, the greater the nominal joint angle which is negative to component durability.

For the above reasons, it would be desirable to reduce standout to avoid premature wear and unwanted noise from the driveline in addition to overcoming other deficiencies in the prior art as outlined above.

### SUMMARY OF THE INVENTION

In a disclosed embodiment of this invention, a shaft body is coupled to a single or tandem drive axle and a yoke portion is integrally formed as one piece with the shaft body to reduce standout and assembly weight. In the single drive axle configuration, the shaft can be an input shaft that is coupled to and integral with the drive axle assembly, which includes an axle housing defining a bowl and a carrier having a differential gear assembly mounted within the bowl. The input shaft has a first end that is operably connected to drive the differential gear assembly and a second end with the integral yoke portion. A driveshaft includes a mating yoke portion coupled to the yoke portion of the axle input shaft through a universal joint assembly.

In the tandem drive axle configuration with a forward-rear axle connected to a rear-rear axle with an interaxle driveshaft, the shaft can be an output shaft that has a first end coupled to a differential gear assembly of the forward-rear axle. The output shaft has a second end with the integral yoke portion. The interaxle driveshaft includes a mating yoke portion at one end to form the universal joint assembly.

In the preferred embodiment, the integral yoke member is incorporated into an output shaft for a forward-rear axle. The shaft body is rotatably supported on a bearing pack for rotation relative to the axle housing. The carrier is installed within the bowl formed within the axle housing and a bowl cover is fastened to the axle housing to enclose the differential gear assembly within the axle housing. In this forward-rear axle tandem configuration, a support member mounts the bearing pack to the bowl cover.

The integral yoke portion and shaft reduces standout, improving driveline angularity and slip allowance. Additionally, the number of separate components is reduced, which decreases cost and overall weight. These and other features of the present invention can be best understood from the following specifications and drawings, the following of which is a brief description.

### BRIEF DESCRIPTION OF THE DRAWINGS

FIG. 1A is a schematic view of a driveline assembly with a single drive axle.

FIG. 1B is a schematic view of a driveline assembly with a tandem drive axle.

FIG. 2 is a schematic view of a known universal joint assembly.

FIG. 3 is a side view of a prior art driveline assembly.

FIG. 4 is a side view of a driveline assembly incorporating the subject invention.

### DETAILED DESCRIPTION OF A PREFERRED EMBODIMENT

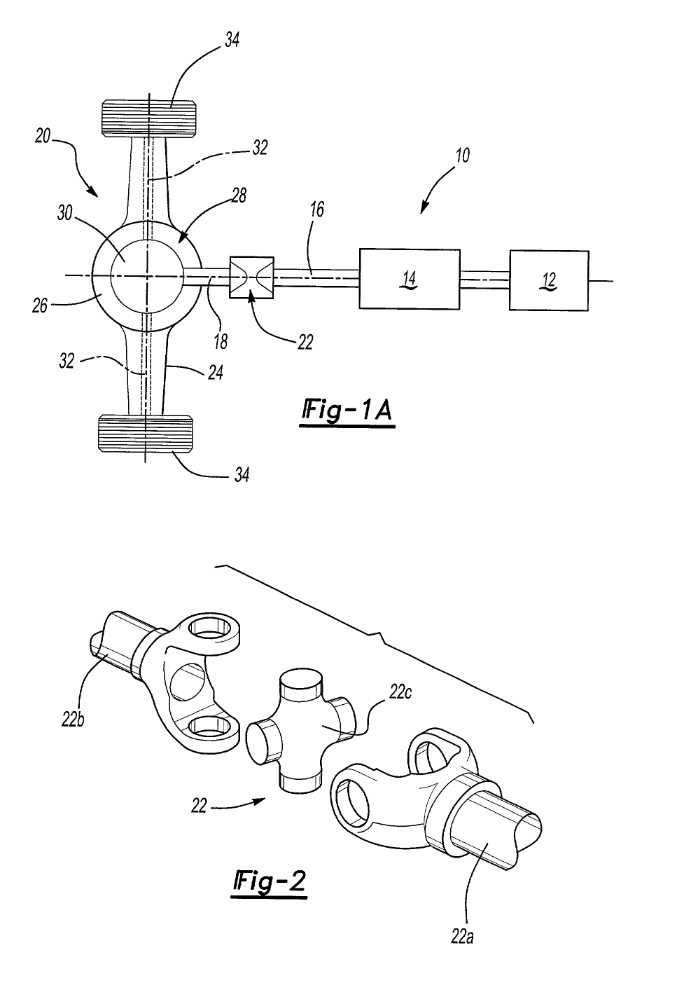

A vehicle driveline assembly 10 with a single rear drive axle is shown in FIG. 1A. An engine 12 and transmission 14 provide a driving output torque to an input driveshaft 16. The driveshaft 16 is coupled to an input shaft 18 for a drive axle 20 with a universal joint 22. The drive axle 20 includes an axle housing 24 that defines a bowl 26 for a carrier or differential 28. The carrier 28 includes a differential gear assembly 30 that splits rotational input torque from the longitudinally extending input shaft 18 into input torque for a pair of laterally extending axle shafts 32. The axle shafts 32 are coupled to wheels 34 that drive the vehicle.

An alternate embodiment of a driveline assembly 110 with a tandem drive axle is shown in FIG. 1B. An engine 112 and transmission 114 provide driving torque to an input driveshaft 116. The driveshaft 116 is coupled to an input shaft 118 for a tandem drive axle 120 with a first universal joint assembly 122a.

The tandem drive axle 120 includes a forward-rear axle 120a and a rear-rear axle 120b that are coupled together with an interaxle driveshaft 132. The forward-rear axle 120a includes an axle housing 124a that defines a bowl 126a for a carrier or differential 128a. The carrier 128a includes a differential gear assembly 130a that splits torque from the input shaft 118 into torque for the forward-rear and rear-rear drive axles. Each axle similarly drives axle shafts in a manner as shown in FIG. 1A.

The rear-rear axle 120b includes an axle housing 124b that defines a bowl 126b for a carrier or differential 128b. The carrier 128b includes a differential gear assembly 130b that splits torque from the interaxle driveshaft 132 into torque for driving axle shafts in a similar manner as shown in FIG. 1A and as noted above. An output, or throughshaft 134 from the forward-rear axle 120a is coupled to the interaxle driveshaft 132 with a second universal joint assembly 122b. A third universal joint assembly 122c couples the opposite end of the interaxle driveshaft 132 to an input shaft 136 of the rear-rear-axle 120b.

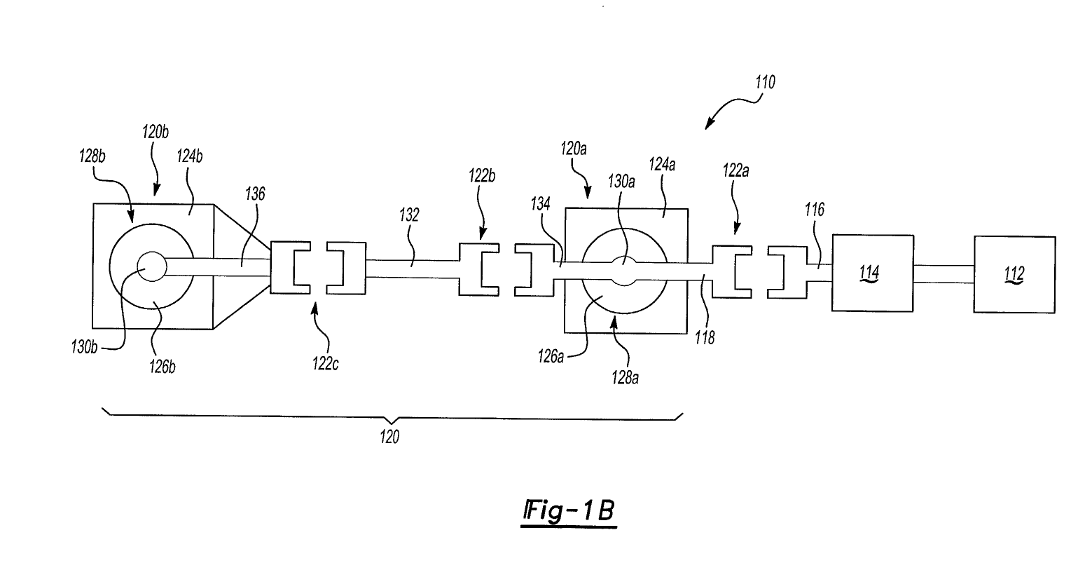

Each universal joint 22, 122a-c includes a first yoke member 22a that is supported on one end of the driveshaft 16 and a second yoke member 22b that is supported on one end of the input shaft 18. The two yoke members 22a, 22b are each mounted to two posts on a cross member 22c, shown in FIG. 2. The combination allows the two yokes 22a, 22b to move angularly relative to each other with respect to the center of the cross member 22c.

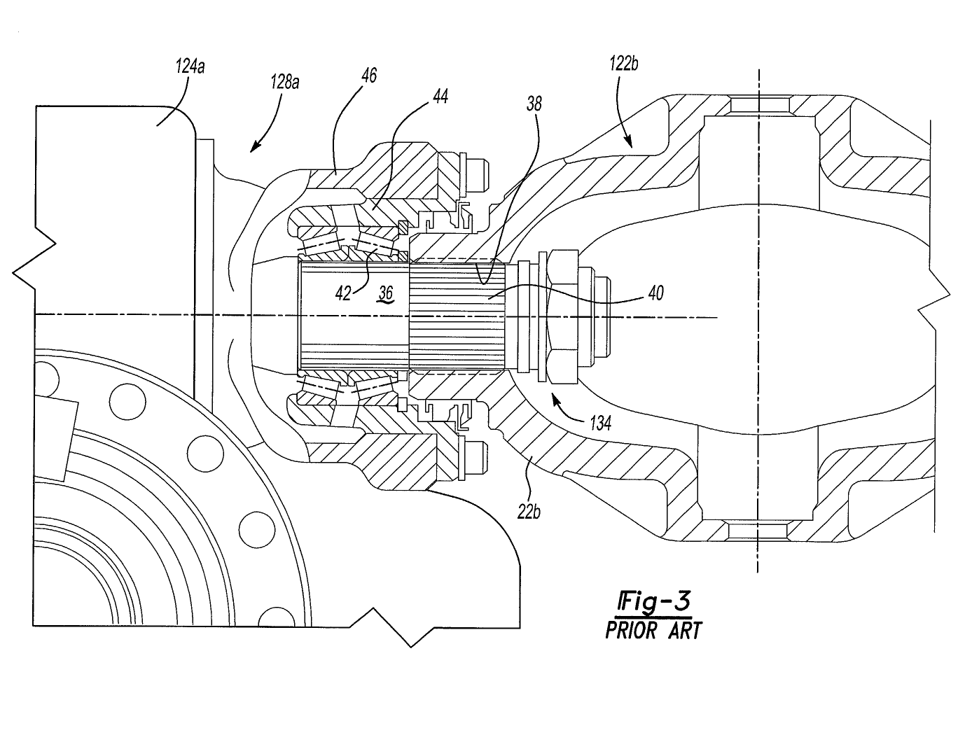

A prior art output shaft 134 and universal joint 122b from the forward-rear axle are shown in FIG. 3. One yoke member 22b includes a splined bore 38 that fits over a splined end 40 of a separate shaft member 36. A bearing assembly 42 rotatably supports the shaft member 36 relative to the axle housing 124a. A mounting member 44 mounts the bearing assembly 42 to a bowl cover 46 that encloses the differential gear assembly 128a within the carrier bowl 126a.

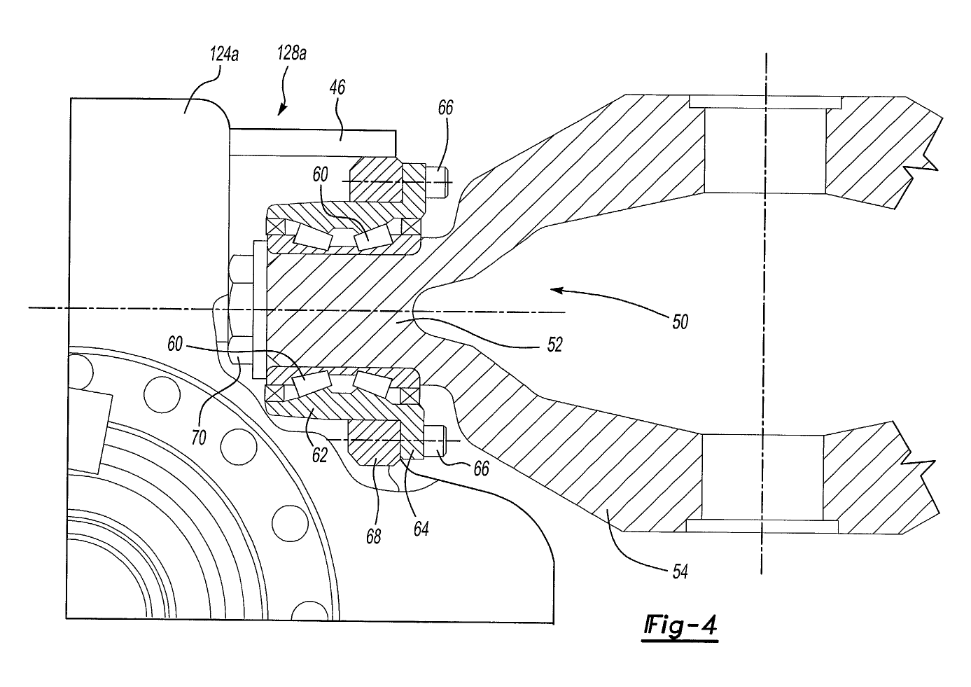

A unique output shaft 50 for a forward-rear axle is shown in FIG. 4. The shaft 50 includes a shaft body 52 coupled to the differential gear assembly 128a at one end and having a yoke portion 54 at the other end that is integrally formed with the shaft body 52 as one piece. The shaft body 52 has a smaller diameter than the yoke portion 54. The shaft 50 can be made from any known manufacturing method such as forging, for example.

The shaft 50 can be any shaft utilized in the driveline assembly 10, 110. Thus, the shaft 50 with the integrally formed yoke portion could be an input shaft, an output shaft, or a throughshaft. However, the subject invention is preferably used only in the output shaft 134 of the forward-rear axle 120a.

The yoke portion 54 is coupled to a mating yoke member supported by the interaxle driveshaft 132. Integrally forming the yoke portion 54 onto the shaft body 52 reduces standout, which improves driveline angularity and slip allowance. Additionally, the integrated shaft 50 reduces cost, assembly time, and overall vehicle weight.

For the forward-rear axle 120a shown in FIG. 4, a cartridge bearing pack 60 rotatably supports the shaft 50 for rotation relative to the axle housing 124a. As discussed above, the carrier 128a is installed within the bowl 126a formed within the axle housing 124a. A support cylinder 68 is attached to a bowl cover 46 that is fastened to the axle housing 124a to enclose the differential gear assembly within the axle housing 124a. A support member 62 mounts the bearing pack 60 to the support cylinder 68 and bowl cover 46. The support member 62 includes a transversely extending lip 64. A plurality of bolts 66 (only two are shown) are used to fasten the support member 62 to the bowl cover 46 or axle housing 124a through the lip 64. A clamping member 70, such as a snap ring or nut, is used to clamp the bearing pack 60. Preferably, the bearing pack 60 is only mounted along the shaft body 52.

The unique shaft 50 having an integrally formed body 52 and yoke portion 54 reduces standout, which improves the overall driveline performance. The use of a cartridge bearing pack 60 and support member 62 in the forward-rear axle 120a further reduces weight and cost and increases packaging space for other components. The shaft with integrally formed body 52 and yoke portion 54 can be used in various driveline locations. However, it should be understood that the mounting configurations would be different than that discussed above with regard to the forward-rear axle.

Although a preferred embodiment of this invention has been disclosed, a worker of ordinary skill in this art would recognize that certain modifications would come within the scope of this invention. For that reason, the following claims should be studied to determine the true scope and content of this invention.

1. A driveline assembly comprising:
a first shaft operably connected to a drive axle; and
a universal joint for interconnecting said first shaft to a second shaft, said universal joint having a first yoke supported on said first shaft and a second yoke supported on said second shaft wherein said first shaft and said first yoke are integrally formed as one piece.

2. An assembly as set forth in claim 1 wherein said drive axle is a forward-rear drive axle from a tandem axle and said first shaft is an output shaft and said second shaft is an interaxle driveshaft that is coupled to said output shaft with said universal joint.

3. An assembly as set forth in claim 2 wherein said forward-rear drive axle includes an axle housing and said output shaft is rotatably supported on a bearing pack for rotation relative to said axle housing.

4. An assembly as set forth in claim 3 including a support mounted to a cover for said axle housing wherein said support engages at least a portion of said bearing pack.

5. An assembly as set forth in claim 1 wherein said drive axle is a tandem drive axle including a first rear axle having a first differential gear assembly and a second rear axle having a second differential gear assembly, said first and second rear axles being interconnected via an interaxle driveshaft, said first shaft being an output shaft driven by said first differential gear assembly and said second shaft being said interaxle driveshaft.

6. An assembly as set forth in claim 1 wherein said drive axle is a single drive axle with said first shaft being an input shaft and said second shaft is a driveshaft.

7. A driveline shaft for a vehicle comprising:
a shaft body for providing driving input or output to a drive axle; and
a yoke portion for coupling with a mating yoke member supported by a connecting shaft wherein said shaft body and said yoke portion are integrally formed as one piece to reduce standout.

8. A shaft as set forth in claim 7 including a bearing pack for rotatably supporting said shaft body and said yoke portion for rotation relative to said drive axle.

9. A shaft as set forth in claim 8 wherein said bearing pack is only mounted along said shaft body.

10. A shaft as set forth in claim 7 wherein said shaft body defines a first predetermined diameter and said yoke portion defines a second predetermined diameter that is greater than said first predetermined diameter.

11. A shaft as set forth in claim 7 wherein said shaft body forms an input shaft and said connecting shaft is a driveshaft.

12. A shaft as set forth in claim 7 wherein said shaft body forms an output shaft and said connecting shaft is an interaxle driveshaft.

13. A drive axle assembly comprising:
an axle housing defining a bowl;
a carrier including a differential gear assembly mounted within said bowl; and
a shaft having a first end operatively coupled to said differential gear assembly and a second end having a yoke portion integrally formed with said shaft as one piece.

14. An assembly as set forth in claim 13 wherein said shaft is an input shaft for driving said differential gear assembly and wherein the axle assembly is powered by a driveshaft having a mating yoke member for coupling to said yoke portion to form a universal joint assembly wherein said input shaft and said driveshaft are oriented at different angles relative to each other and said universal joint assembly provides torque transmission from said driveshaft to said input shaft while accommodating relative movement and angular misalignment between said driveshaft and said input shaft.

15. An assembly as set forth in claim 13 including a bearing pack for rotatably supporting said input shaft relative to said axle housing.

16. An assembly as set forth in claim 15 including a clamping member mounted at said first end of said shaft for clamping said bearing pack.

17. An assembly as set forth in claim 13 wherein said shaft is an output shaft driven by said differential gear assembly and wherein the axle assembly includes an interaxle driveshaft driven by said output shaft, said interaxle driveshaft having a mating yoke member for coupling to said yoke portion to allow relative rotation between said output shaft and said interaxle driveshaft.

18. An assembly as set forth in claim 17 including a bearing pack for rotatably supporting said output shaft relative to said axle housing.

19. An assembly as set forth in claim 18 including a support member with a transversely extending lip for mounting said bearing pack to said axle housing.

20. An assembly as set forth in claim 19 including a support cylinder attached to a bowl cover for supporting said support member.
